(19) United States
(12) Patent Application Publication
(10) Pub. No.: US 2018/0072056 A1
(43) Pub. Date: Mar. 15, 2018

(54) INK JET HEAD DRIVE DEVICE AND INK JET HEAD

(71) Applicant: TOSHIBA TEC KABUSHIKI KAISHA, Tokyo (JP)

(72) Inventors: Noboru NITTA, Tagata Shizuoka (JP); Syunichi ONO, Izu Shizuoka (JP)

(21) Appl. No.: 15/701,800

(22) Filed: Sep. 12, 2017

(30) Foreign Application Priority Data
Sep. 12, 2016 (JP) 2016-178050

(51) Int. Cl. B41J 2/045

(52) U.S. Cl. CPC B41J 2/04588; B41J 2/04581

(57) ABSTRACT

An ink jet head drive device includes a first pulse generation circuit configured to generate a common first pulse for a plurality of nozzles in an array of an ink jet head, a plurality of second pulse generation circuits, each of which is configured to generate a second pulse for one of a group of consecutive nozzles in the plurality of nozzles in the array, a width of each second pulse being set according to correction data provided for each group of consecutive nozzles, a waveform generation circuit configured to generate drive waveforms for the plurality nozzles in the array using the common first pulse and the second pulses, and a drive circuit that receives the drive waveforms and drives a plurality of actuators for ejecting ink droplets from the plurality of nozzles. Each second pulse causes a pressure chamber connected to the plurality of nozzles to expand.

### CROSS-REFERENCE TO RELATED APPLICATION

This application is based upon and claims the benefit of priority from Japanese Patent Application No. 2016-178050, filed Sep. 12, 2016, the entire contents of which are incorporated herein by reference.

### FIELD

Embodiments described herein relate generally to an ink jet head drive device and an ink jet head which is driven by the ink jet head drive device.

### BACKGROUND

In an ink jet head having an array of nozzles, ink droplet volumes ejected from each nozzle in the array are not always uniform. Accordingly, even a solid image that is printed with a numerical equal number of ink droplets ejected from each nozzle may have uneven ink density across the ink jet head width. For a print area wider than a width of one ink jet head, the print area may be divided and multiple ink jet heads each print one divided portion of the print area. In this case, there may also be a difference in the density at a boundary between adjacent heads.

The volumes of the ink droplets ejected from nozzles are not uniform mainly due to structural variations in the ink jet head. For example, diameters of nozzles or a volume of a pressure chamber communicating with a nozzle may not necessarily be uniform nozzle-to-nozzle. The structural variations are often caused by specific characteristics of a processing machine used to manufacture the ink jet head.

In the related art, there is a technique of adjusting the ejection amount for the ink droplets ejected from each nozzle by correcting a pulse width of a driving signal applied to each actuator corresponding to each nozzle. With this technique, the volume of ink droplets ejected from each nozzle can be made more uniform. However, for the volume of ink droplets to be more uniform, it is necessary to set up correction data for correcting the pulse width for each nozzle. For example, an ink jet head having 318 nozzles requires much labor for setting up correction data for 318 nozzles. Furthermore, a circuit for controlling the pulse width for each nozzle in accordance with the correction data is complicated.

### BRIEF DESCRIPTION OF THE DRAWINGS

FIG. 1 is an exploded perspective view illustrating a part of an ink jet head.

FIG. 2 is a cross sectional view of an ink jet head.

FIG. 3 is a side sectional view of an ink jet head.

FIGS. 4A to 4C are schematic diagrams illustrating an operation principle of an ink jet head.

FIG. 5 is each waveform chart of a drive pulse signal applied to an inkjet head, and a Draw pulse signal, a Release pulse signal, and a Push pulse signal which are required to generate the drive pulse signal.

FIG. 6 is a timing chart illustrating a specific example in which an ink pull-in time Draw is adjusted.

FIG. 7 is a block diagram of an ink jet head drive device according to a first embodiment.

FIG. 8 is a circuit diagram of a waveform generation circuit and a drive circuit illustrated in FIG. 7.

FIG. 9 is a graph of diameters of dots formed by ink droplets ejected from each nozzle without providing correction data.

FIG. 10 is a graph of the diameters of dots formed by the ink droplets ejected from each nozzle by providing the correction data.

FIG. 11 is a block diagram of an ink jet head drive device according to a second embodiment.

FIG. 12 is a circuit diagram of a waveform generation circuit and a drive circuit illustrated in FIG. 11.

### DETAILED DESCRIPTION

In general, according to one embodiment, an ink jet head drive device includes a first pulse generation circuit configured to generate a common first pulse for a plurality of nozzles in an array of an ink jet head, a plurality of second pulse generation circuits, each of which is configured to generate a second pulse for one of a group of consecutive nozzles in the plurality of nozzles in the array, a width of each second pulse being set according to correction data provided for each group of consecutive nozzles, a waveform generation circuit configured to generate drive waveforms for the plurality nozzles in the array using the common first pulse and the second pulses, and a drive circuit that receives the drive waveforms and drives a plurality of actuators for ejecting ink droplets from the plurality of nozzles. Each second pulse causes a pressure chamber connected to the plurality of nozzles to expand.

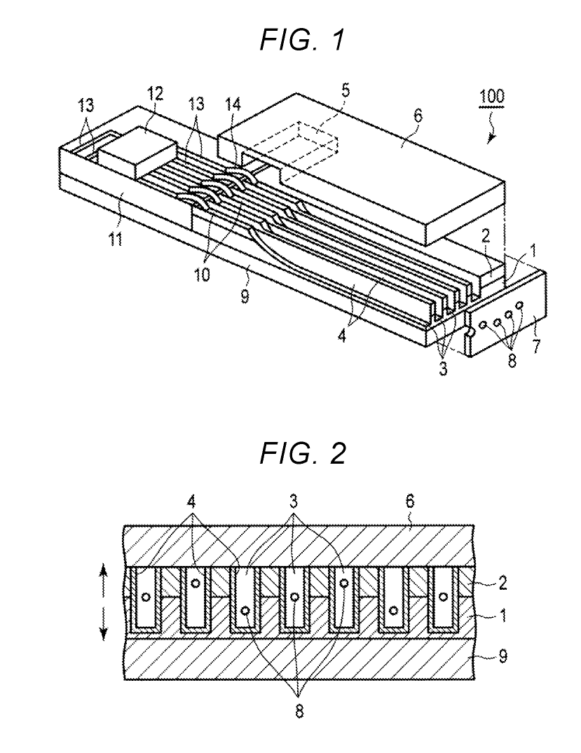

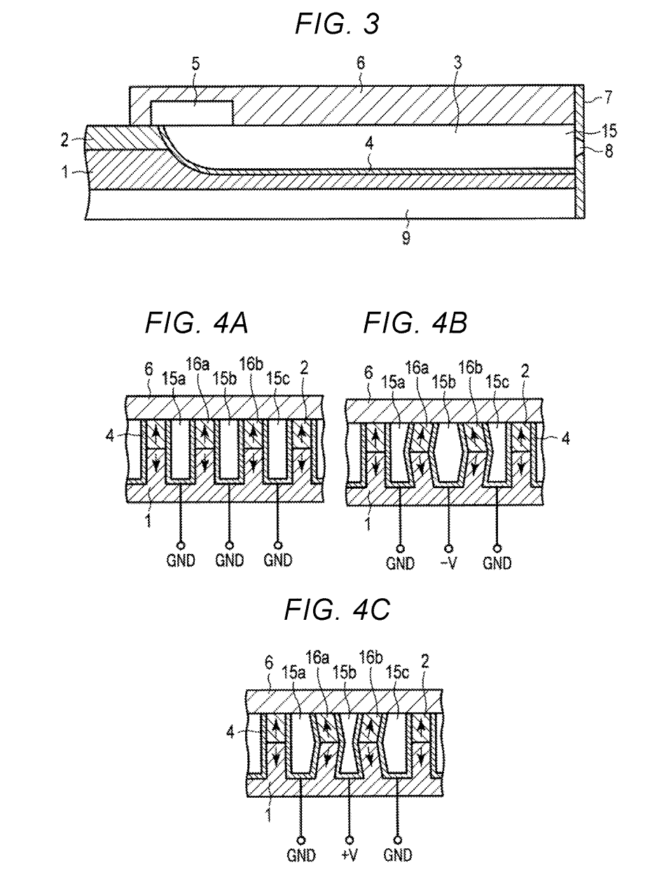

First, a configuration of an ink jet head 100 (hereinafter, abbreviated as a head 100) will be described with reference to FIGS. 1 to 3. FIG. 1 is an exploded perspective view illustrating a part of the head 100. FIG. 2 is a cross sectional view of the head 100. FIG. 3 is a side sectional view of the head 100. In the head 100, a direction parallel to a length of the head 100 is referred to as a longitudinal direction, and a direction perpendicular to the longitudinal direction is referred to as a lateral direction.

As illustrated in FIG. 1, the head 100 includes a rectangular base substrate 9. In the head 100, a first piezoelectric plate 1 is attached to an upper surface of the base substrate 9, and a second piezoelectric plate 2 is attached to the first piezoelectric plate 1. The first piezoelectric plate 1 and the second piezoelectric plate 2, which are bonded to each other, have polarizations opposite to each other along a direction parallel to thicknesses of the piezoelectric plates 1 and 2, as indicated by the arrows in FIG. 2.

The base substrate 9 is formed by a material having a small dielectric constant and a small difference of a thermal expansion coefficient from the piezoelectric plates 1 and 2. For example, alumina (Al₂O₃), silicon nitride (Si₃N₄), silicon carbide (SiC), aluminum nitride (AlN), lead zirconate titanate (PZT), or the like may be used as a material for the base substrate 9. Lead zirconate titanate (PZT), lithium niobate (LiNbO₃), lithium tantalate (LiTaO₃), or the like may be used as materials for the piezoelectric plates 1 and 2.

In the head 100, multiple elongated grooves 3 are cut from an upper surface of the piezoelectric plate 1 toward a bottom surface of the piezoelectric plate 2. The grooves 3 are equally spaced and are parallel with one another. The grooves 3 have open upper ends and closed bottom ends. A cutting machine can be used for forming the grooves 3.

As illustrated in FIGS. 2 and 3, the head 100 has electrodes 4 provided on inner walls of the respective grooves 3. Each electrode 4 has a two-layered structure of nickel (Ni) and gold (Au). The electrode 4 is uniformly formed in each groove 3 by, for example, a plating method. A method of forming the electrode 4 is not limited to the plating method. A sputtering method, an evaporation method, or the like can be used.

As illustrated in FIG. 1, the head 100 includes an extraction electrode 10 at a rear edge of each groove 3 toward a rear upper surface of the second piezoelectric plate 2. The extraction electrode 10 is connected to the electrode 4.

As illustrated in FIGS. 1 and 3, the head 100 includes a top plate 6 and an orifice plate 7. The top plate 6 closes upper ends of the grooves 3. The orifice plate 7 closes front edges of the grooves 3. In the head 100, a plurality of pressure chambers 15 are formed in the grooves 3 shielded by the top plate 6 and the orifice plate 7. The pressure chambers 15 each have, for example, a depth of 300 μm and a width of 80 μm, and are arranged in parallel with a pitch of 169 μm. However, the shape of the pressure chamber 15 is not necessarily uniform due to variations or the like in manufacturing characteristics of a cutting machine used in forming the plurality of pressure chambers 15. For example, the cutting machine may form 16 pressure chambers 15 at once, and this can be repeated 20 times to form 320 pressure chambers 15. However, if machine blades forming each of 16 pressure chambers 15 at once have individual differences, then resulting shapes of the pressure chambers 15 will have similar differences due to the differences in the machine blades resulting in a periodicity in the shapes of the pressure chambers 15 across the nozzle array. In addition, the shapes of the pressure chamber 15 may also slightly change due to changes in a processing temperature and the like during the repetitive processing (e.g., 20 passes of the cutting tool). A slight change in shapes of the pressure chambers 15 may lead to an uneven ink density.

The top plate 6 includes a common ink chamber 5 at a rear bottom surface of the top plate 6. The orifice plate 7 includes nozzles 8 facing grooves 3, respectively. The nozzle 8 communicates with the facing groove 3, that is, the pressure chamber 15. The nozzle 8 is tapered from the pressure chamber 15 toward an ink ejection side, which is opposite of the pressure chamber 15. The nozzles 8 corresponding to three adjacent pressure chambers 15 are grouped, and within each group heights of the three nozzles are shifted at a constant interval in a height direction of the groove 3 (vertical direction of the paper surface of FIG. 2). In FIG. 2, positions of the nozzles 8 are schematically illustrated. The nozzle 8 can be formed by, for example, a laser processing machine. There are two methods for determining positions of nozzles 8 to be formed by the laser processing machine. One method is optically setting a position of a laser beam. The other method is mechanically moving a workpiece (e.g., the orifice plate 7), while the laser stays stationary, as a method of setting processing positions for each nozzle 8. For a large number of the nozzles 8, both methods may be used in combination. However, if drilling is performed using both optical positioning and mechanical positioning, then periodic errors may occur in shapes of the holes due to minute changes during each repeated positioning processing. The possible periodicity in the shapes or positioning of the holes produced by laser processing is also one of the causes of a minute periodic errors leading to an uneven ink density.

As illustrated in FIG. 1, in the head 100, a printed board 11 on which a conductive pattern 13 is formed is attached on a rear upper surface of the base substrate 9. In the head 100, a drive IC 12 is mounted on the printed board 11. In the drive IC 12, an ink jet head drive device, which will be described below, is embedded. The drive IC 12 is connected to the conductive pattern 13. The conductive pattern 13 is connected to each extraction electrode 10 through conductive wires 14 by bonding. One drive IC 12 may drive the electrodes corresponding to all the nozzles 8. However, when one driver IC drives a large number of electrodes, there are several disadvantages. For example, a chip size increases and thereby a yield decreases, wiring of an output circuit is complicated, heat generation during drive is concentrated, and it is not possible to correspond to an increase/decrease in the number of nozzles by increasing/decreasing the number of driver ICs, or the like. Accordingly, for example, in a head with 320 nozzles 8, four driver ICs 12, each having 80 output circuits, may be used. However, in this case, an output waveform from the driver ICs 12 has a spatial periodicity in the direction of the array of the nozzles 8 due to differences or the like in resistances of wires in the driver IC 12. Strength of the periodicity varies depending on the individual differences or the like in the driver ICs 12. The spatial periodicity of the output waveform may also lead to an uneven ink density.

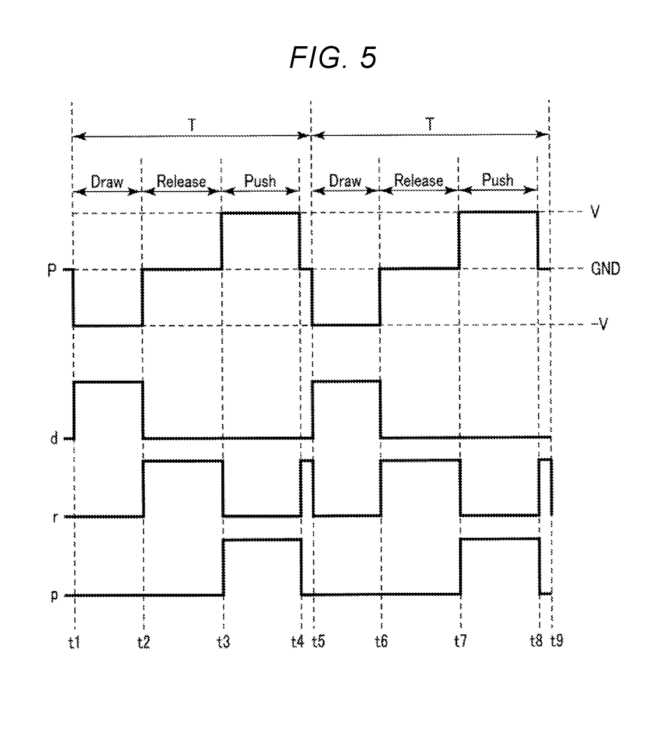

Next, an operation principle of the head 100 configured as described above will be described with reference to FIGS. 4 and 5.

In FIG. 4A, all of the electrodes 4, on the inner walls of the pressure chambers 15a, 15b, and 15c, are grounded GND. In this state, a partition wall 16a interposed between the pressure chambers 15a and 15b and a partition wall 16b interposed between the pressure chambers 15b and 15c are not subjected to any distortion. The state illustrated in FIG. 4A is referred to as a normal state.

In FIG. 4B, a negative voltage −V is applied to the electrode 4 in the pressure chamber 15b and the electrodes 4 in the pressure chambers 15a and 15c remain grounded GND. In this state, an electric field due to the voltage −V acts on the partition walls 16a and 16b in a direction orthogonal to a polarization direction of the piezoelectric plates 1 and 2. By the action, the partition walls 16a and 16b are deformed outward so as to expand a volume of the pressure chamber 15b. The state illustrated in FIG. 4B is referred to as an expanded state.

In FIG. 4C, a positive voltage +V is applied to the electrode 4 in the pressure chamber 15b and the electrodes 4 of the pressure chambers 15a and 15c on both sides thereof remain grounded GND. In this state, an electric field of the voltage V acts on the partition walls 16a and 16b in a direction opposite to the direction of the deformation of the partition walls 16a and 17 in FIG. 4B. By the action, the partition walls 16a and 16b are deformed inward so as to contract the volume of the pressure chamber 15b. The state of FIG. 4C is referred to as a contracted state.

Thus, when the nozzles 8 eject ink droplets while communicating with the pressure chamber 15b, at first, in the head 100, the pressure chamber 15b changes from the normal state to the expanded state in step S1. When the pressure chamber enters the expanded state, the partition walls 16a and 16b on both sides of the pressure chamber 15b are deformed outward so as to expand the volume of the pressure chamber 15b as illustrated in FIG. 4B. As a result of the deformation, the pressure in the pressure chamber 15b decreases, and ink flows into the pressure chamber 15b from the common ink chamber 5.

Next, in the head 100, the pressure chamber 15b changes from the expanded state to the normal state in step S2. When the pressure chamber returns to the normal state, the partition walls 16a and 16b on both sides of the pressure chamber 15b are recovered as illustrated in FIG. 4A. By the recovery, the pressure in the pressure chamber 15b increases, and ink droplets are ejected from the nozzles 8 corresponding to the pressure chambers 15b. Thus, the partition wall 16a separating the pressure chambers 15a and 15b and the partition wall 16b separating the pressure chambers 15b and 15c act as actuators, which apply pressure vibration to the inside of the pressure chamber 15b having the partition walls 16a and 16b as wall surfaces.

Next, in the head 100, the pressure chamber 15b changes from the normal state to the contracted state in step S3. When the pressure chamber enters the contracted state, the partition walls 16a and 16b on both sides of the pressure chamber 15b are deformed inward so as to reduce the volume of the pressure chamber 15b as illustrated in FIG. 4C. By the deformation, the pressure in the pressure chamber 15b further increases. After the ink droplets are ejected, the pressure in the pressure chamber 15b decreases, and the pressure vibration remaining in the pressure chamber 15b is canceled.

In the head 100, the pressure chamber 15b changes from the contracted state to the normal state in step S4. When the pressure chamber returns to the normal state, the partition walls 16a and 16b on both sides of the pressure chamber 15b are recovered as illustrated in FIG. 4A.

FIG. 5 illustrates a waveform of a drive pulse signal P applied to the pressure chamber 15b, which acts as an actuator, and each waveform of a Draw pulse signal d, a Release pulse signal r, and a Push pulse signal p which are required to generate the drive pulse signal P, so as to perform operations of the aforementioned steps S1 to S4. In FIG. 5, time T is required to eject one drop of ink droplet. The time T includes ink pull-in time Draw, ink ejection time Release, and cancel time Push. As illustrated in FIG. 5, the ink pull-in time Draw corresponds to a pulse width of the Draw pulse signal d, the ink ejection time Release corresponds to a pulse width of the Release pulse signal r, the cancel time Push corresponds to a pulse width of the Push pulse signal p. The pulse widths, that are the ink pull-in time Draw, the ink ejection time Release, and the cancel time Push, are normally determined as appropriate values according to conditions such as ink to be used, temperature, and the like for each head 100.

In FIG. 5, the Draw pulse signal d is turned on in the head 100 at time t1. The Draw pulse signal d is continuously ON during the ink pull-in time Draw. When the Draw pulse signal d is turned on, the drive pulse signal P applies a negative voltage −V to the electrode of the pressure chamber 15b. Thus, the pressure chamber 15b changes from the normal state to the expanded state (step S1).

After the ink pull-in time Draw elapses to reach time t2, the Release pulse signal r is turned on in the head 100. The Release pulse signal r is continuously ON during the ink ejection time Release. When the Release pulse signal r is turned on, the drive pulse signal P decreases to the ground voltage GND. Thus, the pressure chamber 15b returns from the expanded state to the normal state (step S2).

After the ink ejection time Release elapses to reach time t3, the push pulse signal p is turned on. The push pulse signal p is continuously ON during the cancel time Push. When the push pulse signal p is turned on, the drive pulse signal P applies a positive voltage +V to the electrode of the pressure chamber 15b. Thus, the pressure chamber 15b changes from the normal state to the expanded state (step S3).

After the cancel time Push elapses to reach time t4, the drive pulse signal P decreases to the ground voltage GND. Thus, the pressure chamber 15b returns from the expanded state to the normal state (step S4). Thus, in the head 100, one drop of ink droplet is ejected by the drive pulse signal P from the nozzle 8 communicating with the pressure chamber 15b, during a period T from time t1.

The Draw pulse signal d is turned on again at time t5, in the head 100. Subsequently, at time t6, time t7 and time t8, the Draw pulse signal d, the Release pulse signal r, and the Push pulse signal p are sequentially turned on and off in the same manner as in the aforementioned time t2, time t3, and time t3. Thus, in the head 100, a second drop of ink droplet is ejected from the nozzle 8 communicating with the pressure chamber 15b by the drive pulse signal P occurring during a period T from time t5.

As described above, ink droplets can be continuously ejected from the nozzle 8 by repeating the operations as for the period from time t1 to time t4 after time t5. Here, the number of ink droplets to be ejected is determined by duration of ON time of an enable signal (not illustrated). For example, if the duration of ON time of the enable signal is equal to the time T, the number of ink droplets is “1”, and if the duration of ON time is equal to twice the time T, the number of ink droplets is “2”. Thus, by adjusting the duration of the ON time of the enable signal, the head 100 can perform gradation printing through a so-called multi-drop method in which one dot is formed by a variable number of ink droplets.

In the multi-drop method, ink density is adjusted by the number of ink droplets. However, even an imaged printed with an equal number of ink droplets ejected from each nozzle 8 may have uneven ink density due to the manufacturing variations described above. Such density unevenness may not be sufficiently removed solely by an adjustment of the number of ink droplets.

It is known that the volume of the ink droplet depends on the ink pull-in time Draw, which is a time to pull the ink into the pressure chamber 15b. When the ink pull-in time Draw is equal to a half cycle (AL) of the pressure vibration, the volume of the ink droplet becomes maximum, and when the time is shorter than the half cycle (AL) of the pressure vibration, the volume of the ink droplet is reduced.

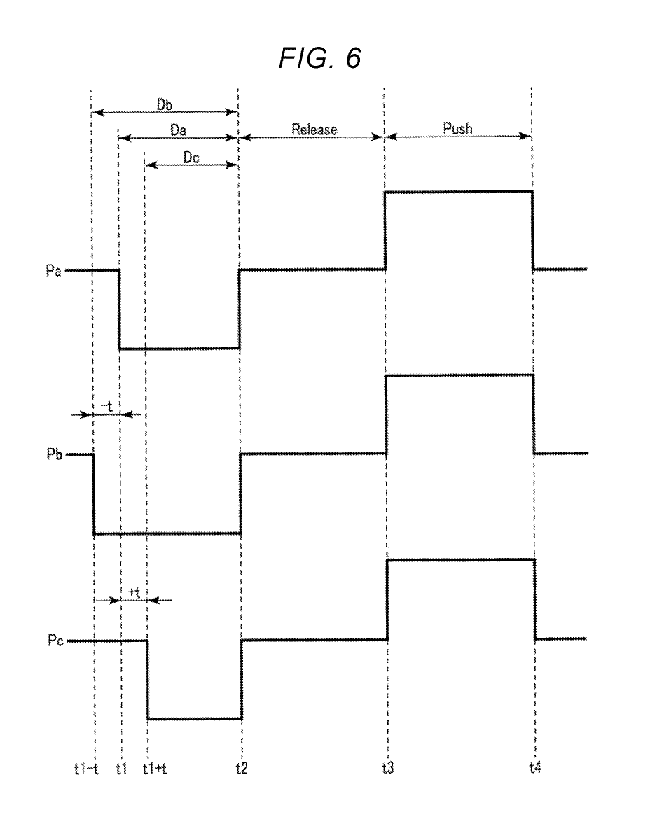

Therefore, the volumes of the ink droplets ejected from each nozzle 8 are made uniform by adjusting the ink pull-in time Draw according to the correction data, and thereby density unevenness is removed. FIG. 6 is a timing chart illustrating a specific example in which the ink pull-in time Draw is adjusted. In FIG. 6, pulse waveforms Pa, Pb, and Pc all indicate the waveform of the drive pulse signal P applied to the actuator of the pressure chamber 15b. For the sake of convenience of description, the pulse waveform Pa coincides with the drive pulse signal P illustrated in FIG. 5, and the pulse waveform Pa is used as a reference waveform before correction.

As can be seen by comparing the pulse waveforms Pa, Pb, and Pc, timing at a point of time t1 is changed within a range from time −t to +t. The amount of a change in the timing at time t1 is determined by correction data. For example, if the correction data specifies advancing of the timing at time t1, that is, in a direction toward −t, the ink pull-in time Draw is longer than the reference waveform (Db>Da). In contrast, if the correction data specifies delaying of the timing at, that is, in a direction toward +t, the ink pull-in time Draw is shorter than the reference waveform (Da>Dc). In this way, by shifting the timing at time t1 in the direction toward −t or the direction toward +t, the ink pull-in time Draw can be varied. That is, it is possible to adjust the volume of the ink droplet ejected from the nozzle.

If the ink pull-in time Draw changes, conditions for cancelling pressure vibration remaining in the pressure chamber 15b changes. Accordingly, it is preferable to adjust the ink ejection time Release and the cancel time Push according to the adjustment of the ink pull-in time Draw. However, if an adjustment range of the ink pull-in time Draw is small, the amount of adjustment of the ink ejection time Release and the cancel time Push is negligibly small. Therefore, the ink ejection time Release and the cancel time Push are excluded from correction data and are kept constant.

If the ink pull-in time Draw is adjusted for each nozzle 8, the number of the correction data is as many as the number of nozzles 8. The number of circuits for adjusting the ink pull-in time Draw according to the correction data is also as many as the number of nozzles. Accordingly, the circuit scale increases. Therefore, a plurality of consecutive nozzles is grouped, and the ink pull-in time Draw is adjusted for each group.

Hereinafter, embodiments (first and second embodiments) of an ink jet head drive device will be described. The ink jet head drive devices according to the first and second embodiments can reduce ink density unevenness caused by manufacturing variations or the like using correction data smaller than the number of nozzles, can reduce the circuit scale, and can simplify the correction data setting operation.

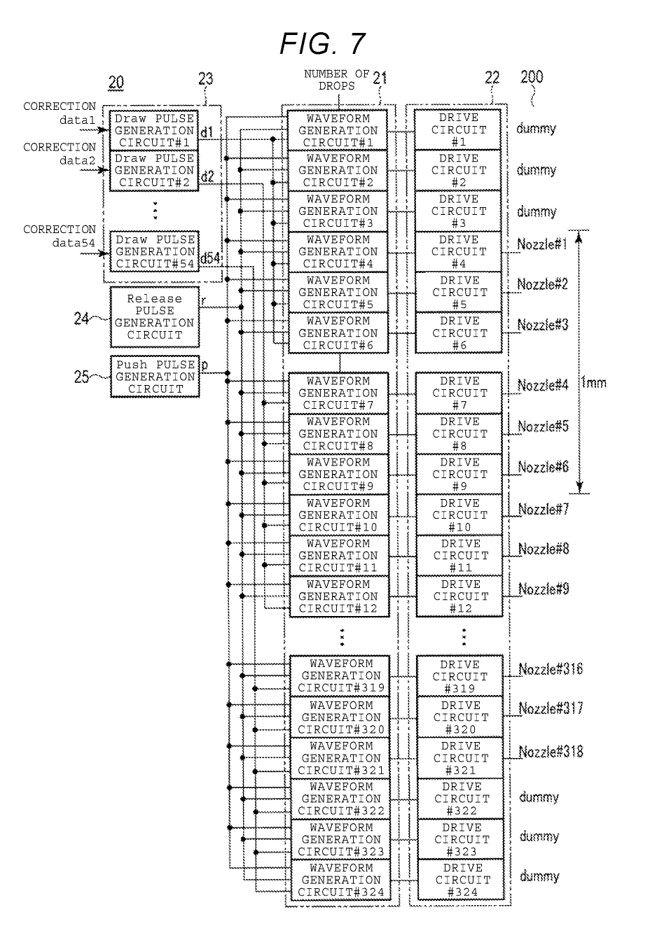

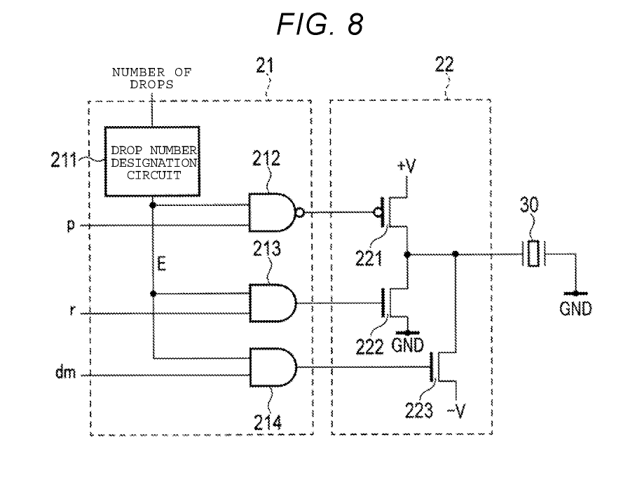

First, the first embodiment will be described with reference to FIGS. 7 and 8.

FIG. 7 is a block diagram of an ink jet head drive device 20 (also referred to for simplicity as a drive device 20) according to the first embodiment. The drive device 20 corresponds to a head 200 including an array of 324 nozzles are arranged in one direction. However, in the head 200, a phenomenon may occur in which the ejection amount increases due to crosstalk between the nozzles on an end portion side of the array. Thus, as illustrated in FIG. 7, three nozzles each at both ends of the array are used as dummy nozzles, from which ink is not ejected. Therefore, the head 200 illustrated in FIG. 7 performs printing by ejecting ink droplets from 318 nozzles (Nozzle #1 to Nozzle #318) between the both ends of the array.

The drive device 20 includes a waveform generation circuit 21 and a drive circuit 22 corresponding to 324 nozzles including the dummy nozzles. That is, the drive device 20 includes 324 waveform generation circuits (waveform generation circuits #1 to #324) 21 and 324 drive circuits (drive circuits #1 to #324) 22. The waveform generation circuit 21 generates a waveform of the drive pulse signal P applied to an actuator of the corresponding nozzle. The drive circuit 22 outputs the drive pulse signal P of the drive waveform generated by the waveform generation circuit 21 to the actuator of the corresponding nozzle to drive the actuator.

The drive device 20 includes a circuit that generates the Draw pulse signal d, the Release pulse signal r, and the Push pulse signal p, which are necessary for generating the drive pulse signal P, that is, a Draw pulse generation circuit 23, a Release pulse generation circuit 24, and a Push pulse generation circuit 25 is provided. In the first embodiment, each set of six consecutive nozzles is grouped, from one end of the array, including the dummy nozzles. That is, the total of the 324 nozzles are grouped into 54 nozzle groups. The ink pull-in time Draw is adjusted for each nozzle group as one unit. Accordingly, as illustrated in FIG. 7, the 324 waveform generation circuits 21 and the 324 drive circuits 22 are similarly grouped by six consecutive pieces corresponding to the nozzle groups, which include the dummy nozzles at the ends of the array. The nozzle groups at the ends of array each include three nozzles from which ink is ejected. With fewer active nozzles included in each of the nozzle groups at the ends of the array as compared to the other nozzle groups, which have six nozzles, the adjustment resolution is higher resolution at the ends of the array. Furthermore, the drive device 20 includes 54 Draw pulse generation circuits (Draw pulse generation circuits #1 to #54) 23 corresponding to the groups of the waveform generation circuits 21 and the drive circuits 22. The Release pulse generation circuit 24 and the Push pulse generation circuit 25 are each provided with one piece.

Correction data data1 to data54 are input to each Draw pulse generation circuit 23. The correction data data1 is correction data for three dummy nozzles on one end of the array and nozzles Nozzle#1 to Nozzle#3. The correction data data2 is correction data for the nozzles Nozzle#4 to Nozzle#9. Hereinafter, in the same manner, the correction data data1 is correction data for the nozzles Nozzle#316 to Nozzle#318 and the three dummy nozzles on the other end of the array.

Each of the correction data data1 to data54 is stored in a memory of a printer in which, for example, the head 200 is mounted. Alternatively, the correction data maybe stored in a memory embedded in a drive IC of the head 200. Each Draw pulse generation circuit 23 varies ON timing of the Draw pulse signals d1 to d54 within a range of time t1 satisfying −t≦t1≦t1+t in accordance with the correction data data1 to data54.

The drive device 20 is wired such that the common Draw pulse signals d1 to d54 are supplied to each of the waveform generation circuits 21 belonging to the corresponding group from each Draw pulse generation circuit 23. The drive device 20 is wired such that the Release pulse signal r and the Push pulse signal p are supplied to all the waveform generation circuits 21 from the Release pulse generation circuit 24 and the Push pulse generation circuit 25.

The Release pulse generation circuit 24 and the Push pulse generation circuit 25 correspond to a first pulse generation circuit which generates a common first pulse for all the nozzles in the array in the ink jet head. Each Draw pulse generation circuit 23 corresponds to a plurality of second pulse generation circuits which correspond to a plurality of consecutive nozzle groups in the array, receive correction data for the nozzle groups, and generate second pulses that change pulse widths in accordance with the correction data.

FIG. 8 is a circuit diagram of one waveform generation circuit 21 and the drive circuit 22 paired with the waveform generation circuit 21. The other waveform generation circuits 21 and drive circuits 22 are the same as in FIG. 8, and thus, description thereof will be omitted.

The waveform generation circuit 21 includes a drop number designation circuit 211, a NAND circuit 212, and two AND circuits 213 and 214. The drop number designation circuit 211 receives information for designating the number of ink drops which are ejected into one dot form each nozzle, a so-called drop number. The drop number is determined based on print data from a controller of a printer in which the head 200 is mounted. The drop number designation circuit 211 determines duration of ON time of an enable signal E according to the input drop number. The drop number designation circuit 211 outputs the enable signal E to the NAND circuit 212 and the two AND circuits 213 and 214.

The NAND circuit 212 receives the enable signal E and the Push pulse signal p, and outputs a negative logical product signal of those to the drive circuit 22. The AND circuit 213 receives the enable signal E and the Release pulse signal r, and outputs a logical product signal of those to the drive circuit 22. The other AND circuit 214 receives the enable signal E and the Draw pulse signal dm (m: 1 to 54), and outputs a logical product signal of those to the drive circuit 22.

The drive circuit 22 includes a P-type MOSFET 221 of negative logic input and two N-type MOSFETs 222 and 223. The drive circuit 22 uses the negative logical product signal output from the NAND circuit 212 as a gate signal of the P-type MOSFET 221. The drive circuit 22 uses the logical product signal output from the AND circuit 213 as a gate signal of the N-type MOSFET 222 and uses the logical product signal output from the AND circuit 214 as a gate signal of the N-type MOSFET 223.

In the drive circuit 22, the P-type MOSFET 221 has a drain terminal connected to a +V power supply terminal and a source terminal connected to a drain terminal of the N-type MOSFET 222. A source terminal of the N-type MOSFET 222 is grounded. A drain terminal of the N-type MOSFET 223 is connected to a connection point between the source terminal of the P-type MOSFET 221 and the drain terminal of the N-type MOSFET 222, and a source terminal of the N-type MOSFET 223 is connected to a −V power supply terminal. In the drive circuit 22, the connection point between the source terminal of the P-type MOSFET 221 and each drain terminal of the N-type MOSFET 222 and the N-type MOSFET 223 is used as an output terminal of the drive pulse signal P, and a nozzle actuator 30 is connected to the output terminal.

According to the waveform generation circuit 21 and the drive circuit 22, when the enable signal E is turned on and the Draw pulse signal dm is turned on, the N-type MOSFET 223 is turned on, and thereby, the −V voltage is applied to the actuator 30. When the Draw pulse signal dm is off and the Release pulse signal r is turned on, the N type MOSFET 223 is turned off and the N type MOSFET 222 is turned on, and thereby, a level of the voltage applied to the actuator 30 drops to the ground potential GND. When the Release pulse signal r is off and the Push pulse signal p is turned on, the N-type MOSFET 222 is turned off and the P-type MOSFET 221 is turned on, and thereby, the +V voltage is applied to the actuator 30. When the push pulse signal p is off and the Release pulse signal r is turned on, the P-type MOSFET 221 is turned off and the N-type MOSFET 222 is turned on, and thereby, a level of the voltage applied to the actuator 30 drops to the ground potential GND.

Thus, the drive device 20 first outputs the Draw pulse signal dm from the 54 Draw pulse generation circuits (Draw pulse generation circuits #1 to #54) 23 at time t1 during only the ink pull-in time Draw, as illustrated in FIG. 5. Next, the drive device 20 outputs the Release pulse signal r from the Release pulse generation circuit 24 at time t2 during only the ink ejection time Release. Subsequently, the drive device 20 outputs the push pulse signal p from the push pulse generation circuit 25 at time t3 as cancel time Push. Subsequently, the drive device 20 outputs the Release pulse signal r from the Release pulse generation circuit 24 at time t4 during only a period until the point of time t5. By repeating such an operation by using the drive device 20, the number of ink droplets input to the drop number designation circuit 211 is continuously ejected from the nozzles.

Here, the timing t1 at which the Draw pulse signal dm is turned on varies within a range from (t1−t) to (t1+t) depending on the correction data. The ink pull-in time Draw of the pressure chamber 15 corresponding to each nozzle of the group to which the Draw pulse signal dm whose ON timing varies in a direction of −t is supplied is longer than the ink pull-in time Draw of the pressure chamber 15 corresponding to each nozzle of the group in which the Draw pulse signal dm is turned on at timing of the point of time t1. In contrast, the ink pull-in time Draw of the pressure chamber 15 corresponding to each nozzle of the group to which the Draw pulse signal dm whose ON timing varies in a direction of +t is supplied is shorter than the ink pull-in time Draw of the pressure chamber 15 corresponding to each nozzle of the group in which the Draw pulse signal dm is turned on at timing of the point of time t1.

Therefore, when the drive pulse signal P having the same waveform is given, the correction data in which output timing of the Draw pulse signal dm is (t1−t) is provided to the Draw pulse generation circuit 23, with respect to the nozzle group of the group in which the volume of the ink droplet is smaller than that of nozzle groups of the other groups. In contrast, the correction data in which output timing of the Draw pulse signal dm is (t1+t) is supplied to the Draw pulse generation circuit 23, with respect to the nozzle groups of the group in which the volume of the ink droplet is larger than the nozzle groups of the other groups.

In this way, by providing appropriate correction data to each Draw pulse generation circuit 23 by using a group of a plurality of consecutive nozzles as one unit, it is possible to make the volumes of the ink droplets ejected from all the nozzles forming the nozzle rows of the head 200 uniform. As a result, density unevenness that might otherwise be caused by manufacturing variations and the like can be made inconspicuous. At this time, the number of correction data matches the total number of groups of nozzles and is thus significantly reduced as compared to the total number of nozzles. Thus, since the amount of correction data can be reduced, the burden required for determining and setting the correction data can be reduced. Since the number of Draw pulse generation circuits 23 may also match the number of groups of nozzles, the circuit size can be smaller than would be the case for a circuit necessary to individually handle every one of the number of nozzles.

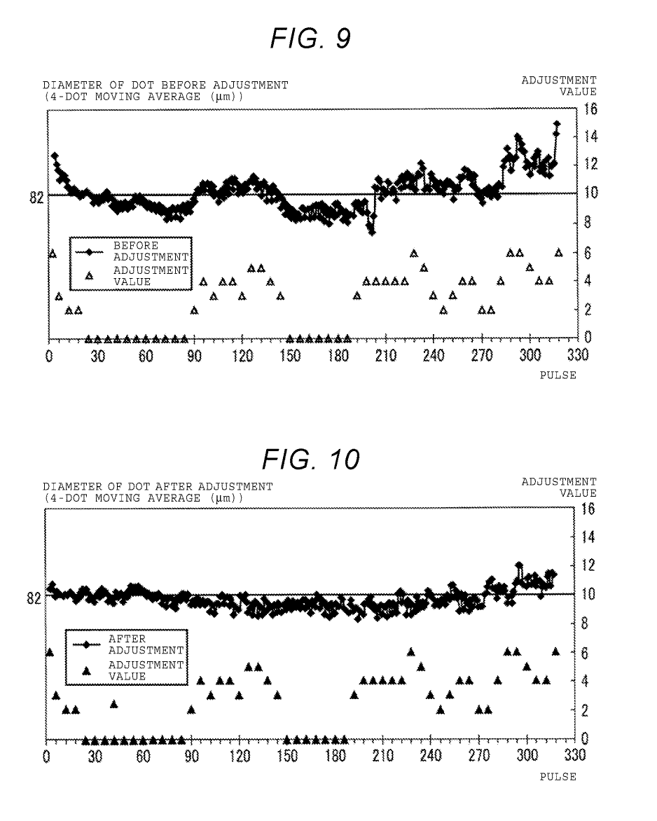

FIG. 9 is a graph of diameters (a 4-dot moving average diameter (μm)) of dots formed from ink droplets ejected from each nozzle without providing correction data to the Draw pulse generation circuit 23 for each nozzle. In FIG. 9, marks presented by white triangles illustrate the diameters with adjustment for groups of six consecutive nozzles. FIG. 10 is a graph of diameters (4-dot moving average (μm)) of dots formed from ink droplets ejected from each nozzle with the correction data provided to the Draw pulse generation circuit 23. As is apparent from comparison of FIG. 9 and FIG. 10, it is possible to make the dot diameters more uniform by providing the correction data to the Draw pulse generation circuit 23.

In the first embodiment, six consecutive nozzles are grouped, and the ink pull-in time Draw is corrected for each group. Here, the reason why the number of nozzles belonging to one group is set to 6 will be described.

It is known that ink density unevenness is conspicuous in this type of head 200 when solid printing is performed with a uniform gradation value. In particular, it is known that the ink density unevenness is visible when the ink density unevenness is present in a region having a size or period of several millimeters in solid printing. In general, the greater the number of nozzles belonging to each group in this context, the greater the reduction in the circuit scale and the burden of the correction data setting operation. However, since the adjustment resolution is coarser as the group size increases, it may not be possible to adjust to obtain a uniform printing result beyond some ultimate group size. Therefore, from the viewpoint of conspicuousness of the aforementioned density unevenness, the number of nozzles belonging to one group is set such that a region printed by each group of consecutive nozzles is less than or equal to 1 mm. For a head 200 having a 150 dpi nominal printing output, when the printing range is 1 mm or less, the number of nozzles in a group will be 6 or less. Thus, in the present example, six consecutive nozzles are grouped in each group, and the ink pull-in time Draw is corrected on a group basis corresponding to six nozzles in each group.

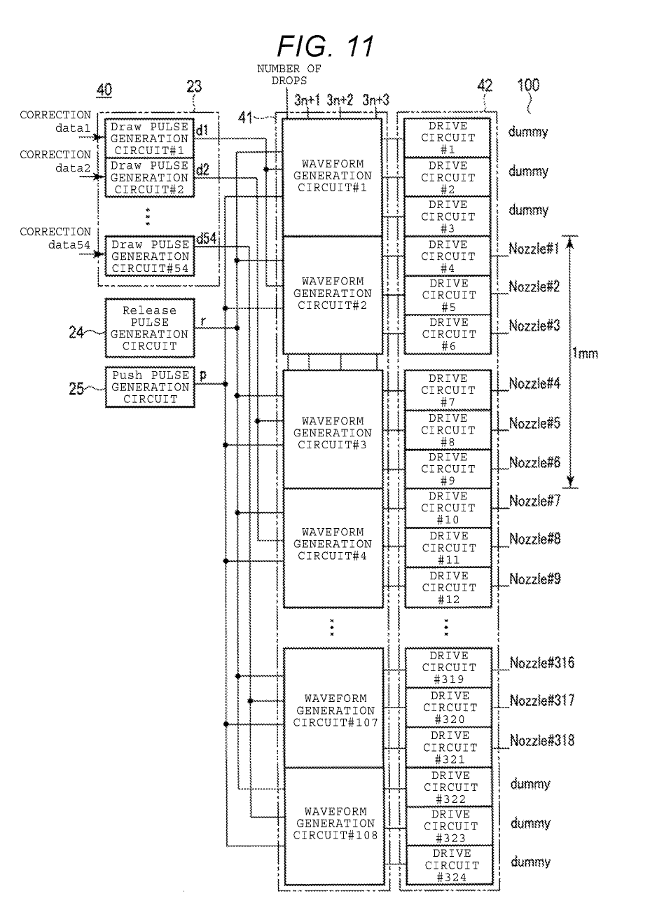

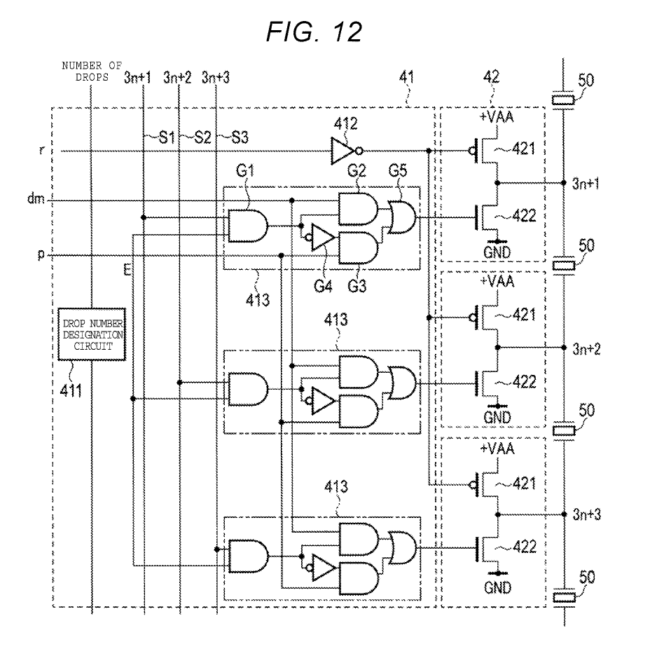

Next, a second embodiment will be described with reference to FIGS. 11 and 12. The same symbols or reference numerals will be attached to the same portions as in FIGS. 7 and 8 described in the first embodiment, and detailed description thereof will be omitted.

FIG. 11 is a block diagram of an ink jet head drive device 40 (hereinafter, referred to as a drive device 40) according to a second embodiment. The drive device 40 corresponds to a shared wall type head 100 including an array of 324 nozzles are arranged in one direction. In the head 100, a phenomenon that the amount of ejection increases due to crosstalk in the nozzle at end portions of the array can occur. To reduce the crosstalk at the ends of the array, it is desirable to finely adjust the amount of ink ejected from nozzles in the end groups of the array. Since ejection from end group nozzles of the array should be controlled more finely (precisely), three nozzles at either ends of the array are provided as dummy nozzles, as illustrated in FIG. 11. In particular, three nozzles at either ends, Nozzle #1 to Nozzle #3, and Nozzle #316 to Nozzle #319, are used for ejecting ink droplets. The shared wall type head 100 illustrated in FIG. 11 performs printing by ejecting ink droplets from 318 nozzles (Nozzle #1 to Nozzle #318) between the both ends of the array.

The drive device 40 includes drive circuits 42 corresponding to 324 nozzles including the dummy nozzles. The drive device 40 includes one waveform generation circuit 41 for each group of the three consecutive drive circuits 42. That is, the drive device 40 includes 324 drive circuits (drive circuits #1 to #324) 42 and 108 waveform generation circuits (waveform generation circuits #1 to #108) 41. The waveform generation circuits 41 respectively generate waveforms of the drive pulse signals P applied to the actuators of its corresponding three nozzles. The drive circuit 42 outputs the drive pulse signal P having the waveform generated by the waveform generation circuit 41 to the actuators of the corresponding nozzle to drive the actuator.

In the shared wall type head 100, since adjacent channels cannot simultaneously perform printing in principle, a divided drive is performed on nozzles in a staggered arrangement. It is common to stagger each set of consecutive three nozzles. With this staggering, the drive pulses are numbered as 3n+1, 3n+2, and 3n+3 (n is an integer, 0, 1, 2, . . . ) sequentially from one end of the array to the other end, and the three groups of nozzles corresponding to the number 3n+1, the number 3n+2, and the number 3n+3 are separately driven. Thus, the drive pulse signals P are not simultaneously output to two or more nozzles in a set of three consecutive nozzles. Therefore, the drive device 40 provides one waveform generation circuit 41 for each group of the three consecutive drive circuits 42.

In the same manner as the drive device 20, the drive device 40 includes 54 Draw pulse generation circuits (Draw pulse generation circuits #1 to #54) 23, one Release pulse generation circuit 24, and one Push pulse generation circuit 25. The drive device 40 is wired such that the common Draw pulse signals d1 to d54 are supplied from the respective Draw pulse generation circuits 23 to corresponding two waveform generation circuits 41. The drive device 40 is wired such that each of the Release pulse signal r and the Push pulse signal p is supplied to all the waveform generation circuits 41 from the Release pulse generation circuit 24 and the Push pulse generation circuit 25.

Also in the second embodiment, the Release pulse generation circuit 24 and the Push pulse generation circuit 25 correspond to a first pulse generation circuit, and each Draw pulse generation circuit 23 corresponds to a second pulse generation circuit.

FIG. 12 is a circuit diagram of one waveform generation circuit 41 and three drive circuits 42 paired with the waveform generation circuit 41. Since the other waveform generation circuit 41 and drive circuit 42 are also the same as in FIG. 12, description thereof will be omitted.

The waveform generation circuit 41 includes a drop number designation circuit 411, a NOT circuit 412, and first to third logic circuits 413. The drop number designation circuit 411 receives information for specifying the number of ink droplets which are ejected into one dot from each nozzle, a so-called drop number. The drop number is given based on print data from a controller of a printer in which the head 100 is mounted. The drop number designation circuit 411 determines duration of ON time of an enable signal E according to the input drop number. The drop number designation circuit 411 outputs the enable signal E to each logic circuit 413.

The NOT circuit 412 receives the Release pulse signal r as an input and outputs an inverted signal thereof to the drive circuit 42.

Each of the first to third logic circuits 413 includes three AND circuits G1, G2, and G3, a NOT circuit G4 of a negative logic, and an OR circuit G5. The AND circuit G1 receives the enable signal E and the selection signals S1, S2, and S3 of the nozzles respectively corresponding to the numbers 3n+1, 3n+2, and 3n+3. More specifically, the AND circuit G1 of the first logic circuit 413 corresponding to the nozzle of the number 3n+1 receives the selection signal S1, the AND circuit G1 of the second logic circuit 413 corresponding to the nozzle of the number 3n+2 receives the selection signal S2, and the AND circuit G1 of the third logic circuit 413 corresponding to the nozzle of the number 3n+3 receives the selection signal S3. The AND circuit G1 outputs a logical product signal of the enable signal E and the selection signals S1, S2, or S3 to the AND circuit G2 and the NOT circuit G4. The AND circuit G2 receives the logical product signal of the AND circuit G1 and the Draw pulse signal dm (m: 1 to 54) and outputs the logical product signal to the OR circuit G5. The NOT circuit G4 receives the logical product signal of the AND circuit G1 and outputs an inverted signal thereof to the AND circuit G3 when the logical product signal is negative logic. The AND circuit G3 receives the inverted signal of the NOT circuit G4 and the PUSH pulse signal p, and outputs the logical product signal to the OR circuit G5. The OR circuit G5 receives the logical product signal of the AND circuit G2 and the logical product signal of the AND circuit G3 and outputs the logical sum signal to the drive circuit 42.

Each of the drive circuits 42 includes a P-type MOSFET 421 having a negative logic input and an N-type MOSFET 422. Each of the drive circuits 42 uses an inverted signal output from the NOT circuit 412 as a gate signal of the P-type MOSFET 421. In addition, each drive circuit 42 uses the logical sum signal output from the OR circuit G5 as a gate signal of the N-type MOSFET 422.

In each drive circuit 42, the P-type MOSFET 421 has a drain terminal connected to a +V power supply terminal and a source terminal connected to the drain terminal of the N-type MOSFET 422. A source terminal of the N-type MOSFET 422 is grounded. The drive circuit 42 uses a connection point between the source terminal of the P-type MOSFET 421 and the drain terminal of the N-type MOSFET 422 as an output terminal of the drive pulse signal P and is connected to two actuators 50 shared by the nozzles adjacent to the output terminal.

For the sake of convenience of description, the drive circuit 42 having the N-type MOSFET 422 which uses the logical sum signal output from the OR circuit G5 of the first logic circuit 413 as a gate signal is referred to as a first drive circuit 42. In the same manner, the drive circuit 42 having the N-type MOSFET 422 which uses the logical sum signal output from the OR circuit G5 of the second logic circuit 413 as a gate signal is referred to as a second drive circuit 42, and the drive circuit 42 having the N-type MOSFET 422 which uses the logical sum signal output from the OR circuit G5 of the third logic circuit 413 as a gate signal is referred to as a third drive circuit 42

According to the waveform generation circuit 41 and the drive circuit 42 having the aforementioned configuration, for example, when the selection pulse signal S2 is turned on and the selection signals S1 and S3 are off and the Release pulse signal r is turned on, the P-type NOSFETs 421 of the first to third drive circuits 42 are turned on. At this time, since there is no potential difference between the actuators 50 corresponding to the three adjacent nozzles, the pressure chambers corresponding to the respective nozzles are in the normal state.

In this state, when the enable signal E is turned on and the Release pulse signal r is off and the Draw pulse signal dm is turned on, an output of the AND circuit G2 of the second logic circuit 413 increases to a high level. Then, the N-type MOSFET 422 of the second drive circuit 42 is turned on, and thereby, a potential of the actuator 50 corresponding to the central nozzle in the group of the three adjacent nozzles is lower than potentials of the actuators 50 corresponding to both adjacent nozzles by −V. As a result, the pressure chamber corresponding to the central nozzle enters the expanded state, and the ink flows into the pressure chamber.

When the Draw pulse signal dm is off and the Release pulse signal r is turned on, the P-type MOSFETs 421 of the first to third drive circuits 42 are all turned on as described above. Thus, the pressure chamber corresponding to the central nozzle returns to the normal state. As a result, ink droplets are ejected from the central nozzle.

When the Release pulse signal r is off and the Push pulse signal p is turned on, outputs of the AND circuits G3 of the first and third logic circuits 413 increase to a high level. Then, the N-type MOSFETs 422 of the first and third drive circuits 42 are turned on, and thereby, the potential of the actuator 50 corresponding to the central nozzle in the group of the three adjacent nozzles is higher than the potentials of the actuators 50 corresponding to the both adjacent nozzles by +V. As a result, the pressure chamber corresponding to the central nozzle enters the contracted state and the pressure vibration is suppressed.

Thus, as illustrated in FIG. 5, for example, when the selection signal S2 is turned on, the drive device 40 first makes 54 Draw pulse generation circuits (Draw pulse generation circuits #1 to #54) 23 output the Draw pulse signal dm at time t1 during only the ink pull-in time Draw. Next, the drive device 40 makes the Release pulse generation circuit 24 output the Release pulse signal r at time t2 during only the ink discharge time Release. Subsequently, the drive device 40 makes the push pulse generation circuit 25 output the push pulse signal p at time t3 during the cancel time Push. Subsequently, the drive device 20 makes the Release pulse generation circuit 24 output the Release pulse signal r at time t4 during only a period until the point of time t5. By repeating the operations by using the drive device 40, the number of ink droplets which is input to the drop number designation circuit 411 is ejected from the nozzle of the nozzle number 3n+2.

Such an operation is also the same as a case where the other selection signal S1 or S3 is turned on. That is, if the drive device 40 repeats the same operation when the selection signal S1 is turned on, ink droplets of the number of drops which has been input to the drop number designation circuit 411 are ejected from the nozzle of the nozzle number 3n+1. If the drive device 40 repeats the same operation when the selection signal S3 is turned on, ink droplets of the number of drops which have been input to the drop number designation circuit 411 are continuously ejected from the nozzle of the nozzle number 3n+3.

In the same manner as in the first embodiment, the timing t1 at which the Draw pulse signal dm is turned on varies within a range from (t1−t) to (t1+t) depending on the correction data. Thus, also in the second embodiment, appropriate correction data can be given to each Draw pulse generation circuit 23 by using a group as one unit, and thereby, the volumes of the ink droplets ejected from all the nozzles forming the nozzle row of the head 100 can be more uniform. As a result, the drive device 40 can be provided in which density unevenness caused by manufacturing variations and the like can be made inconspicuous by a correction data set smaller than the total number of nozzles, even for a head 100 of a shared-wall type. Likewise, a reduction in circuit size and the burden associated with the correction data setting operation can be achieved.

By making the number of nozzles belonging to a group to be a multiple of the number of divisions for the shared-wall type head 100, the configurations of the waveform generation circuit 41 and the drive circuit 42 are simplest. Accordingly, it is desirable that the number of nozzles belonging to the group is a multiple of the number of divisions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An ink jet head drive device, comprising:
a first pulse generation circuit configured to generate a common first pulse for a plurality of nozzles in an array of an ink jet head;
a plurality of second pulse generation circuits, each of which is configured to generate a second pulse for one of a group of consecutive nozzles in the plurality of nozzles in the array, a width of each second pulse being set according to correction data provided for each group of consecutive nozzles;
a waveform generation circuit configured to generate drive waveforms for the plurality nozzles in the array using the common first pulse and the second pulses;
a drive circuit that receives the drive waveforms and drives a plurality of actuators for ejecting ink droplets from the plurality of nozzles, wherein
each second pulse causes a pressure chamber connected to the plurality of nozzles to expand.

2. The ink jet head drive device according to claim 1, wherein the first pulse causes the pressure chamber to contract.

3. The ink jet head drive device according to claim 1, wherein a volume of an ink droplet ejected from each nozzle in the plurality of nozzles is determined by a width of a corresponding second pulse.

4. The ink jet head drive device according to claim 1, wherein
the inkjet head is a shared-wall type inkjet head, and
the number of consecutive nozzles in each group of nozzles is an integral multiple of a number of drive divisions in the shared-wall type ink jet head.

5. The ink jet head drive device according to claim 1, wherein
a group of consecutive nozzles in the plurality of nozzles at each end of the array includes dummy nozzles from which ink droplets are not ejected and active nozzles from which ink droplets are ejected, and
an amount of ink droplets ejected from each of the groups of consecutive nozzles is separately controlled by the drive circuit.

6. The ink jet head drive device according to claim 1, wherein
a number of active nozzles from which ink droplets are ejected included in a group of consecutive nozzles in the plurality of nozzles at each end of the array is less than a number of active nozzles included in the other groups of consecutive nozzles in the plurality of nozzles in the array.

7. An ink jet head, comprising:
a plurality of nozzles arrayed in nozzle rows along a first direction;
a plurality of actuators, each configured to eject ink from a nozzle in the plurality of nozzles;
a first pulse generation circuit configured to generate a common first pulse for all nozzles in the plurality of nozzles;
a plurality of second pulse generation circuits, each of which is configured to generate a second pulse for one of a group of consecutive nozzles in the plurality of nozzles along a nozzle row according to correction data received for the group of consecutive nozzles, a width of the second pulses being varied according to the correction data;
a waveform generation circuit configured to receive the first pulse and the second pulses and generate drive waveforms; and
a drive circuit configured to receive the drive waveforms and drive the plurality of actuators according to the drive waveforms, wherein
the second pulses cause pressure chambers associated with each nozzle in the plurality of nozzles to expand.

8. The inkjet head according to claim 7, wherein the first pulse causes the pressure chambers to contract.

9. The ink jet head according to claim 7, wherein volumes of ink droplets ejected from the plurality of nozzles are determined by the widths of the second pulses.

10. The ink jet head according to claim 7, wherein wherein
the ink jet head is a shared-wall type ink jet head, and
the number of consecutive nozzles in each group of nozzles is an integral multiple of a number of drive divisions in the shared-wall type ink jet head.

11. The ink jet head according to claim 7, wherein
a group of consecutive nozzles in the plurality of nozzles at each end of the array includes dummy nozzles from which ink droplets are not ejected and active nozzles from which ink droplets are ejected, and
an amount of ink droplets ejected from each of the groups of consecutive nozzles is separately controlled by the drive circuit.

12. The ink jet head drive device according to claim 7, wherein
a number of active nozzles from which ink droplets are ejected included in a group of consecutive nozzles in the plurality of nozzles at each end of the array is less than a number of active nozzles included in the other groups of consecutive nozzles in the plurality of nozzles in the array.

13. An ink jet head, comprising:
a first piezoelectric plate attached to an upper surface of a substrate;
a second piezoelectric plate attached to an upper surface of the first piezoelectric plate, wherein
the first and second piezoelectric plates have polarizations opposite to each other along a direction parallel to thicknesses of the first and second piezoelectric plates;
a plurality of pressure chambers each comprising:
a groove cut from an upper surface of the second piezoelectric plate toward a bottom surface of the first piezoelectric plate, shielded by a top plate at the upper surface of the second piezoelectric plate and by an orifice plate at a front edge of the groove;
an electrode on inner walls of the groove; and
a nozzle in the orifice plate at the front edge of the groove;
a first pulse generation circuit that generates a common first pulse for the nozzles in the plurality of pressure chambers;
a plurality of second pulse generation circuits that generate second pulses for groups of consecutive nozzles in the plurality of pressure chambers, respectively,
the plurality of second pulse generation circuits configured to receive correction data for each group of consecutive nozzles, and generate a second pulse having a width determined according to the correction data for each group;
a waveform generation circuit configured to receive the first pulse and the second pulses and generate drive waveforms according to the first pulse and the second pulses; and
a drive circuit configured to receive the drive waveforms and drive the plurality of pressure chambers, wherein
the second pulses causes the pressure chambers to expand.

14. The ink jet head according to claim 13, wherein the first pulse causes the pressure chambers to contract.

15. The ink jet head according to claim 13, wherein volumes of ink droplets ejected from the plurality of nozzles are determined by the widths of the second pulses.

16. The ink jet head according to claim 13, wherein
a group of consecutive nozzles in the plurality of nozzles at each end of the array includes dummy nozzles from which ink droplets are not ejected and active nozzles from which ink droplets are ejected, and
an amount of ink droplets ejected from each of the groups of consecutive nozzles is separately controlled by the drive circuit.

17. The ink jet head according to claim 13, wherein
a printing image which is printed by each group of consecutive nozzles is 1 mm or less.
